(19) United States
(12) Patent Application Publication
(10) Pub. No.: US 2006/0147879 A1
(43) Pub. Date: Jul. 6, 2006

(54) Rotary medical or dental instrument

(75) Inventor: Peter Mueller, Ebersach (DE)

Correspondence Address: NIXON PEABODY, LLP, 401 9TH STREET, NW, SUITE 900, WASHINGTON, DC, 20004-2128, US

(73) Assignee: VDW GmbH, Muenchen (DE)

(21) Appl. No.: 10/543,309

(22) PCT Filed: Jan. 27, 2004
(86) PCT No.: PCT/EP04/00686

§ 371 Date: Jul. 26, 2005

(30) Foreign Application Priority Data
Jan. 28, 2003 (DE) 103 03 202.9

(51) Int. Cl. A61C 3/02

(52) U.S. Cl. 433/165

(57) ABSTRACT

Rotational medical or dental instrument (1), in particular a drill, a cutting tool, a file or the like. The instrument (1) has a shaft (5) for mounting the instrument (1) in a drive part and has an instrument part (2) which is connected to the shaft (5). Marks (6) are provided on the shaft (5) in a number corresponding to a maximum number of uses of the instrument (1). The marks (6) are provided in such a way that they can be removed. After each use of the instrument, one of the marks is removed so that the remaining number of marks (6) indicates how often the instrument (1) can still be used. After removing the last mark (6), the instrument (1) is spent, so that it can be discarded.

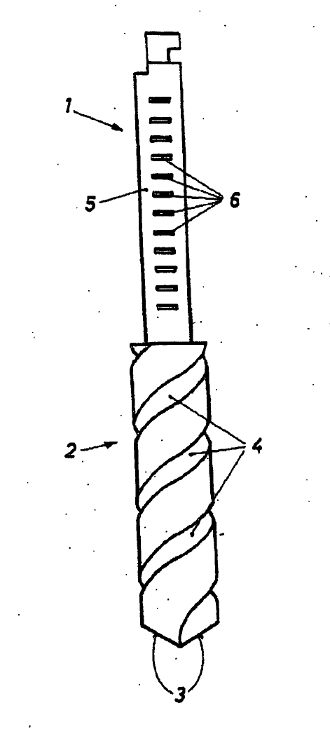

### BACKGROUND OF THE INVENTION

1. Field of Invention

This invention relates to a medical or dental rotational instrument, in particular a drill, a reamer or cutter, a file or the like, having a shaft for arranging the instrument in a drive part and an instrument part connected to the shaft.

2. Description of Related Art

Instruments of the type to which the invention relates are used in the medical field, namely, in both human and veterinary medicine, and in the dental field for microsurgery on bones and for dental treatments. In particular, these instruments include dental root canal instruments and implant drills or cutters for introducing drill taps into bony substance, in particular, for dental implants.

Such instruments are under stress during use, which allows only a limited number of uses of each individual instrument. If this number of allowed uses is exceeded, there is an increased risk of breakage of the instrument part, for example. This is true, in particular, for dental root canal instruments, but applies also to implant drills or cutters. In the latter case, adequate sharpness of the cutting edges of the instrument part, i.e., the drilling or cutting tool is especially important. The allowed number of uses of each individual instrument must be limited because the wear on these cutting edges is relatively great, especially when machining the outer hard bony layer, and the extent of wear is very difficult to ascertain. In the case of implant drills or cutters, this allowed number of uses is twelve, for example, whereas in the case of root canal instruments, this number is only six to eight.

In order not to exceed this maximum allowed number of uses, it has been necessary in the past to list each use of the instrument and to correlate the lists with each individual instrument, which demands great care and considerable effort, in particular, when entire instrument sets having a multitude of different instruments are used. However, even when extreme care and great effort are expended, it is still unavoidable that errors occur in listing the uses.

### SUMMARY OF THE INVENTION

A primary object of this invention is, therefore, to create an instrument of the type defined in the introduction which is designed so that the number of uses of the instrument can be recognized easily.

This object is achieved through the provision of marks on a shaft of the instrument in a number corresponding to the maximum number of uses of the instrument, whereby the marks are provided in such a way that they can be removed.

In the case of the inventive instrument, after each use, a mark provided on the shaft may be removed, so that the number of remaining marks indicates the number of uses that are still possible. After the last mark has been removed from the instrument, the instrument is to be regarded as no longer usable.

Therefore, the manufacturer can provide marks on each instrument in a number corresponding to the maximum recommended number of uses, so that removal of the last mark can be regarded as a sign that the instrument is showing signs of wear. Since the marks are provided on the instrument itself, the possibility of incorrectly assigning uses to other instruments is ruled out.

An especially preferred exemplary embodiment of the inventive instrument is described in greater detail below with reference to the accompanying drawing.

### BRIEF DESCRIPTION OF THE DRAWINGS

The sole FIGURE of the drawings illustrates a preferred embodiment of the inventive instrument in a side view.

### DETAILED DESCRIPTION OF THE INVENTION

The preferred embodiment of the inventive instrument shown in the drawing is an implant drill, but it is self-evident that the inventive embodiment may also be provided on other rotational instruments, such as other types of drills or cutting tools, or files for use in the medical or dental fields, whenever the number of times that individual instruments can be used is limited due to wear-related causes.

The implant drill 1 depicted in the drawing has a working part or area 2 with cutting edges 3 on its end face and grooves 4 for removing the shavings generated. The working area 2 of the implant drill 1 is connected to a shaft 5 which is mostly cylindrical and serves to secure the implant drill 1 in a drive part. The shaft 5 frequently has etched or electro-eroded information about its diameter, length, manufacturer, etc.

As shown in the drawing, marks 6 in the form of transverse bars, the number of which corresponds to the maximum recommended number of uses of the implant drill 1, are provided along the shaft 5. These marks 6 may also be provided in some other form, e.g., in the form of dots. An implant drill 1 that has not been used will have as many marks 6 as the maximum number of uses recommended by the manufacturer of the implant drill 1. This may be twelve, for example.

The marks 6 may be designed in various forms, assuming that they can be removed after each use. They may thus be concealed, removed, filled up or worn away. To do so, a suitable abrasive tool may be used. Examples of the embodiments of marks 6 include etching, electro-erosion or application of a material, in particular, the application of an ink or other material that is capable of being “scratched off.”

After each use of the implant drill 1, one of the marks 6 is removed. This may expediently be accomplished by a rubber polisher which is also supplied by the manufacturer of the implant drill 1. This may also be a rubber polisher, which is generally used in a dental practice. In the case of ink marks, they may also be removed with the blade of a knife or under some circumstances with a fingernail. After removing the last mark 6, the implant drill 1 is regarded as blunt, and therefore, spent and to be discarded.

The procedure described above with respect to an implant drill is also applicable accordingly for the all of the types of instruments to which the invention was indicated above as being applicable.

1-10. (canceled)

11. A medical or dental rotational instrument, having a shaft for mounting the instrument in a drive part and having a working part connected to the shaft,
wherein marks are provided on the shaft in a number corresponding to a maximum number of uses of the instrument, the marks being adapted for individual removal after each use of the instrument.

12. The instrument according to claim 11, wherein the marks are adapted for removal by abrasion.

13. The instrument according to claim 12, wherein the marks are adapted for removal with an abrasive tool.

14. The instrument according to claim 11, wherein the marks have been etched into the shaft.

15. The instrument according to claim 11, wherein the marks have been electro-eroded onto the shaft.

16. The instrument according to claim 11, wherein the marks have been flat electro-eroded marks onto the shaft.

17. The instrument according to claim 11, wherein the marks are formed of a material that has been applied onto the shaft.

18. The instrument according to claim 17, wherein said material is an ink.

19. The instrument according to claim 11, wherein the marks are in the form of a series of dots or lines positioned along the length of the shaft.

20. The instrument according to claim 11, wherein the instrument is a tool selected from the group consisting of drills, reamers, cutters, and files.

21. The instrument according to claim 17, wherein said material is adapted for removal by being scratched off.
